(19) United States
(12) Patent Application Publication
(10) Pub. No.: US 2026/0168779 A1
(43) Pub. Date: Jun. 18, 2026

(54) Device and method for inspecting openings of a powder metallurgy disk body with multiple openings

(71) Applicant: Chengdu University, Chengdu City (CN)

(72) Inventors: Wei FENG, Chengdu City (CN); Jie ZHENG, Chengdu City (CN); Jianneng ZHENG, Chengdu City (CN); Lin HUANG, Chengdu City (CN); Zhenyu ZHU, Chengdu City (CN); Yongyou ZHU, Chengdu City (CN); Yun WU, Chengdu City (CN); Lin YU, Chengdu City (CN); Jianjun LUO, Chengdu City (CN); Chaokun CN FU, Chengdu City (CN); Mingchun ZHAO, Chengdu City (CN); Mingliang XIANG, Chengdu City (CN); Ke ZHANG, Chengdu City (CN); Jianbo NIE, Chengdu City (CN); Dashan GUO, Chengdu City (CN)

(73) Assignee: Chengdu University, Chengdu City (CN)

(21) Appl. No.: 19/224,791

(22) Filed: May 31, 2025

(30) Foreign Application Priority Data
Dec. 18, 2024 (CN) 202411868110.X

(51) Int. Cl. G01B 5/14

(52) U.S. Cl. CPC G01B 5/143

(57) ABSTRACT

A device and a method for inspecting openings of a powder metallurgy disk body with multiple openings, comprising a workbench, wherein an arch frame is fixedly provided on the workbench, an inspection unit for inspecting depth and width of openings in a powder metallurgy disk body is arranged on the arch frame, a positioning and ejection mechanism for positioning and ejecting the powder metallurgy disk body is also arranged on the workbench; lateral micro switches are fixedly mounted on inner side walls of lower ends of the two rods, spring pieces A of the lateral micro switches are arranged inwardly, and rollers are rotatably mounted on upper ends of the two rods via pins; the bottom surfaces of the two lifting plates are both fixedly provided with arc-shaped protrusions, and the two arc-shaped protrusions respectively abut against top surfaces of the two rollers under elastic force of the springs.

### CROSS-REFERENCE

This application claims the benefit of priority from China Patent Application No. CN202411868110.X filed on Dec. 18, 2024, the contents of which are hereby incorporated by reference in their entirety.

### TECHNICAL FIELD

The present invention relates to the technical field of opening inspection of powder metallurgy disks, in particular to a device and a method for inspecting openings of a powder metallurgy disk body with multiple openings.

### BACKGROUND TECHNOLOGY

A structure of a powder metallurgy disk body 1 with multiple openings is shown in FIGS. 1 to 3. A center hole 2 is opened in a middle portion of the powder metallurgy disk body 1, and a keyway 3 connected to the center hole 2 is opened on an inner wall. Four openings 4 are evenly opened on an outer edge of a top surface of the powder metallurgy disk body 1, and the four openings 4 all penetrate outer cylindrical surfaces of the powder metallurgy disk body 1. A processing technology of the powder metallurgy disk body 1 comprises: filling a certain amount of metal powder into a die cavity of a forming die, then pressing it into a blank by a pressing machine, and finally sintering the blank by a sintering furnace. After sintering, the powder metallurgy disk body 1 as shown in FIGS. 1 to 3 can be obtained.

After a batch of powder metallurgy disk bodies 1 are produced in the workshop, the process requires that the four openings 4 in each powder metallurgy disk body 1 be inspected, that is, depth H and width L of the openings 4 are inspected (due to a manufacturing process, the depth and width of some openings 4 may be too small and do not meet the design requirements, so the four openings 4 are required to be inspected).

A method for detecting the four openings 4 of the powder metallurgy disc body 1 in a workshop comprises:
S1, taking out a powder metallurgy disk body 1 to be inspected and placing the powder metallurgy disk body 1 flat on a table surface of a testing table by workers;
S2, measuring depths of the first opening 4 of the powder metallurgy disk body 1 with a vernier caliper, and then measuring widths of the first opening 4 with the vernier caliper by the workers; after measuring, the worker records measured depths and widths;
S3, repeating step S2 three times by the workers to measure the depths and widths of the other three openings 4 of the powder metallurgy disk body 1;
S4, comparing the measured depths of the four openings 4 with standard depth by the workers; if one of the depths is less than the standard depth, the workers determine that the powder metallurgy disk body 1 is an unqualified product;
If the depths of the four openings 4 are all greater than the standard depth, the powder metallurgy disk body 1 is determined to be a semi-qualified product; then the worker compares the widths of the four openings 4 of the semi-qualified product with the standard width respectively. If one width is smaller than the standard width, the semi-qualified product is determined to be an unqualified product; if the widths of the four openings 4 are all greater than the standard width, the semi-qualified product is determined to be a qualified product, thereby finally completing the inspection of the four openings 4 of one powder metallurgy disk body 1;
S5, repeating steps S1 to S4 for multiple times by the workers to inspect the openings of all powder metallurgy disk bodies 1 in the workshop.

However, the method used in the workshop, although capable of inspecting the four openings 4 of the powder metallurgy disk body 1, still suffers from the following technical defects in the technology:
I. As can be seen in steps S1˜S2, since there are four openings 4 in a powder metallurgy disk body 1, it is necessary to measure the depth and width of the four openings 4 in eight processes, which undoubtedly increases the work intensity of the workers. In addition, since there are many processes, then it takes a long time to complete all measurements of the four openings 4 of a powder metallurgy disk body 1, and the number of powder metallurgy disk bodies 1 to be inspected each day is as many as 100 to 120, which undoubtedly reduces the efficiency of the inspection of the openings of the powder metallurgy disk body.
II. In step S4, when the depths and widths of the four openings 4 of a powder metallurgy disk body 1 are measured, it is also necessary to manually compare the depths of each of the four openings 4 with the standard depth, or the widths of each of the four openings 4 with the standard width, in order to determine an unqualified product or a qualified product. A whole comparison process needs to be completed manually, which not only increases the work intensity of the workers, but also reduces the efficiency of the opening inspection of the powder metallurgy disk body. Therefore, there is an urgent need for an inspection device and method that greatly reduces the work intensity of workers and greatly improves the efficiency of opening inspection of powder metallurgy disk bodies.

### SUMMARY OF THE INVENTION

The present invention aims to overcome drawbacks of the prior art, and provide a device and method for inspecting openings of a powder metallurgy disk body with multiple openings, which greatly reduces the work intensity of workers and greatly improves the efficiency of opening detection of the powder metallurgy disk body.

The purpose of the present invention is achieved through following technical solutions: A device for inspecting openings of a powder metallurgy disk body with multiple openings comprising a workbench, wherein an arch frame is fixedly provided on the workbench, an inspection unit for inspecting depth and width of openings in a powder metallurgy disk body is arranged on the arch frame, a positioning and ejection mechanism for positioning and ejecting the powder metallurgy disk body is also arranged on the workbench, and the positioning and ejection mechanism is arranged directly below the inspection unit;
the inspection unit comprises a lifting cylinder fixedly mounted on a top surface of the arch frame, wherein a piston rod of the lifting cylinder penetrates downwardly through the arch frame, a connecting plate is fixedly mounted on an extended end, a horizontally arranged double-acting cylinder is fixedly mounted on a bottom surface of the connecting plate, rods are welded to two piston rods of the double-acting cylinder, lateral micro switches are fixedly mounted on inner side walls of lower ends of the two rods, spring pieces A of the lateral micro switches are arranged inwardly, and rollers are rotatably mounted on upper ends of the two rods via pins;
guide rods are fixedly provided on a top surface of the connecting plate and located at left and right ends of the connecting plate, and lifting plates are slidably sleeved on the two guide rods, springs are sleeved on the two guide rods, and upper and lower ends of the springs are respectively fixedly provided on the lifting plates and the connecting plate; the two lifting plates are both extended outside the rods, and a floating rod is fixedly provided on an extended end, vertical micro switches are fixedly provided on bottom surfaces of the two floating rods, and spring pieces B of the vertical micro switches are arranged downward; the bottom surfaces of the two lifting plates are both fixedly provided with arc-shaped protrusions, and the two arc-shaped protrusions respectively abut against top surfaces of the two rollers under elastic force of the springs.

A plurality of pads supported on grounds are fixedly provided on a bottom surface of the workbench.

The positioning and ejection mechanism comprises a frame fixedly mounted on a surface of the workbench, a stepper motor fixedly mounted on a top surface of the frame, and a turntable fixedly mounted on an output shaft of the stepper motor; a positioning column is fixedly mounted on a top surface of the turntable, a flat key is fixedly mounted on a cylindrical surface of the positioning column along an axial direction of the positioning column, and four through holes are evenly opened in the turntable along a circumferential direction of the positioning column;
a jacking cylinder is fixedly provided on a bottom surface of the frame, at least one piston rod of the jacking cylinder extends into the frame, and a jacking plate is fixedly provided on an extended end, two jacking rods are fixedly provided on a top surface of the jacking plate, both of the two jacking rods penetrate upward through a top edge of the frame, and the two jacking rods are respectively located directly below the two through holes in the turntable.

An outer diameter of the positioning column is compatible with a central hole of the powder metallurgy disk body, and the flat key is compatible with a keyway of the powder metallurgy disk body.

A connecting frame is fixedly provided between the bottom surface of the frame and the workbench.

The lifting cylinder, the positioning column, the turntable and the stepper motor are coaxially arranged.

The two lateral micro switches are symmetrically arranged with respect to the double-acting cylinder, and the two vertical micro switches are symmetrically arranged with respect to the double-acting cylinder.

The inspection device further comprises a controller, and the controller is electrically connected to the lifting cylinder, the double-acting cylinder, the jacking cylinder, the stepper motor, the lateral micro switches and the vertical micro switches via a signal line.

A method for detecting openings of a powder metallurgy disk body with multiple openings, using the device for detecting openings of a powder metallurgy disk body with multiple openings comprises following steps:
S1, positioning of a powder metallurgy disk body to be inspected: S1, taking out a powder metallurgy disk body to be inspected by workers, sleeving the central hole of the powder metallurgy disk body on the positioning column of the positioning and ejection mechanism from top to bottom, and sleeving the keyway of the powder metallurgy disk body on the flat key of the positioning and ejection mechanism from top to bottom; subsequently supporting the powder metallurgy disk body on a top surface of the turntable, thereby achieving the positioning of the powder metallurgy disk body; at this time, a left opening of the powder metallurgy disk body is located directly below the lateral micro switches and the vertical micro switches on a left side, and a right opening of the powder metallurgy disk body is located directly below the lateral micro switches and the vertical micro switches on a right side;
S2, detecting two openings within the powder metallurgy disk body in following steps:
S21, controlling the piston rod of the lifting cylinder of the inspection unit to extend downward, so that the piston rod drives the connecting plate to move downward, the connecting plate drives the double-acting cylinder, two guide rods, two floating rods, two lateral micro switches and two vertical micro switches to move downward synchronously; when the piston rod of the lifting cylinder is fully extended, the lateral micro switches and the vertical micro switches located on the left side both enter the left opening of the powder metallurgy disk body, and meanwhile, the lateral micro switches and the vertical micro switches located on the right side both enter the right opening of the powder metallurgy disk body;
S22, controlling the two piston rods of the double-acting cylinder of the inspection unit to retract inward simultaneously, so that the two piston rods respectively drive the two rods to move inward, the rods drive the lateral micro switches and the rollers to move inward synchronously, and the spring pieces A of the lateral micro switches move toward side walls of the openings; meanwhile, the rollers are gradually staggered with the arc-shaped protrusions on the lifting plates, and in a process of gradually staggering, the lifting plates move downward along the guide rods, the lifting plates drive the floating rods to move downward, the floating rods drive the vertical micro switches to move downward, and the spring pieces B of the vertical micro switches move toward bottom walls of the openings;
when both piston rods of the double-acting cylinder are fully retracted, the rods no longer drive the lateral micro switches to move inward, and meanwhile, the rollers are just staggered from the arc-shaped protrusions on the lifting plates;
if a controller receives an electrical signal from the lateral micro switches or the vertical micro switches, it indicates that width or depth of inspected openings does not meet design requirements, and the workers determine that the powder metallurgy disk body is an unqualified product; at this time, the workers take out the unqualified product in following steps: first, controlling the piston rod of the lifting cylinder to be retracted upward by the workers so that the lateral micro switches and the vertical micro switches are reset upward; then, controlling the piston rod of the jacking cylinder to extend upward; the piston rod drives the jacking plate to move upward, and the jacking plate drives two jacking rods to move upward; the jacking rods pass through the through holes and lift the unqualified product upward along the positioning column; when the unqualified product is lifted to an outside portion of the positioning column, the workers take the unqualified product away;
if the controller does not receive the electrical signal from the lateral micro switches and the vertical micro switches, it indicates that the width or depth of the inspected openings meets the design requirements, and the workers determine that the powder metallurgy disk body is a semi-qualified product, thereby finally completing detection of the two openings within the powder metallurgy disk body;
S3, detecting two openings in the semi-qualified product in following steps:
S31, controlling the two piston rods of the double-acting cylinder to extend outward by the workers, so that the two piston rods respectively drive the two rods to move outward, and the arc-shaped protrusions on the lifting plates abut against a top portion of the rollers again;
S32, controlling the piston rod of the lifting cylinder to retract upward, so that the piston rod drives the connecting plate to move upward, and the connecting plate drives the double-acting cylinder, the two guide rods, the two floating rods, the two lateral micro switches and the two vertical micro switches to move upward synchronously to reset the lateral micro switches and the vertical micro switches;
S33, controlling the stepper motor to start, so that the stepper motor drives the turntable to rotate, the turntable drives the positioning column and the flat key to rotate, and the positioning column and the flat key drive the semi-qualified product to rotate synchronously; when the semi-qualified product is rotated 90 degrees, the controller controls the stepper motor to turn off; at this time, the other two openings in the semi-qualified product enter a detection station, and the lateral micro switches and the vertical micro switches located on the left side enter the left opening of the semi-qualified product; meanwhile, the lateral micro switches and the vertical micro switches located on the right side enter the right opening of the semi-qualified product;
S34, repeating operation of steps S21 to S22 once by the workers;
if the controller receives the electrical signal from the lateral micro switches or the vertical micro switches, it indicates that the width or depth of the inspected openings does not meet the design requirements, and the workers determine that the semi-qualified product is an unqualified product; at this time, the workers take out the unqualified product in following steps: first, controlling the piston rod of the lifting cylinder to be retracted upward by the workers so that the lateral micro switches and the vertical micro switches are reset upward; then, controlling the piston rod of the jacking cylinder to extend upward; when the unqualified product is lifted to an outside portion of the positioning column, the workers take the unqualified product away;
if the controller does not receive the electrical signal from the lateral micro switches and the vertical micro switches, it indicates that the width or depth of the inspected openings meets the design requirements, and the workers determine that the semi-qualified product is a qualified product, so that the workers control the piston rod of the lifting cylinder to extend upward; when the qualified product is lifted up, the workers take the qualified product away, thereby completing the inspection of the two openings in the semi-qualified product, and finally completing the inspection of the four openings in the powder metallurgy disk body;
S4, repeating steps S1 to S3 multiple times by the workers to allow the openings of all powder metallurgy disk bodies in a workshop to be inspected.

The present invention boasts for following advantages: the working intensity of workers is greatly reduced, and the opening detection efficiency of the powder metallurgy disk body is greatly improved.

### BRIEF DESCRIPTION OF THE DRAWINGS

FIG. 1 is an axonometric view of a powder metallurgy disk body;

FIG. 2 is a top view of FIG. 1;

FIG. 3 is a cross-sectional view of A-A of FIG. 2;

FIG. 4 is a schematic diagram of a structure of the present invention;

FIG. 5 is a schematic diagram of a principal section of FIG. 4;

FIG. 6 is a schematic diagram of a structure of an inspection unit;

FIG. 7 is a schematic diagram of the connection of rods, rollers, and lateral micro switches;

FIG. 8 is a schematic diagram of the principal section of FIG. 7;

FIG. 9 is a schematic diagram of the connection between the floating rods, the lifting plates, and the vertical micro switches;

FIG. 10 is a schematic diagram of the connection between the lifting plates and the arc-shaped protrusions;

FIG. 11 is a schematic diagram of the principal section of FIG. 10;

FIG. 12 is an axonometric view of the positioning and ejection mechanism;

FIG. 13 is a schematic diagram of the principal section of FIG. 12;

FIG. 14 is a schematic diagram of achieving the positioning of the powder metallurgy disk body;

FIG. 15 is a schematic diagram of a double-acting cylinder with both piston rods fully extended;

FIG. 16 is a partial enlarged view of part B of FIG. 15;

FIG. 17 is a schematic diagram of a double-acting cylinder with both piston rods fully retracted;

FIG. 18 is a partial enlarged view of part C of FIG. 17;

FIG. 19 is a schematic diagram of an unqualified product being lifted to an outside portion of the positioning column;

FIG. 20 is a schematic diagram of a semi-qualified product performing a rotational motion;

Reference signs in the accompanying figures are indicated as below:
1—powder metallurgy disk body, 2—central hole, 3—keyway, 4—openings; 5—workbench, 6—arch frame, 7—inspection unit, 8—positioning and ejection mechanism; 9—lifting cylinder, 10—connecting plate, 11—double-acting cylinder, 12—rod, 13—lateral micro switch, 14—spring piece A, 15—roller, 16—guide rod, 17—lifting plate, 18—spring, 19—floating rod, 20—vertical micro switch, 21—spring piece B, 22—arc-shaped protrusion; 23—frame, 24—stepper motor, 25—turntable, 26—positioning column, 27—flat key, 28—through hole, 29—jacking cylinder, 30—jacking plate, 31—jacking rods, 32—connecting frame.

### SPECIFIC EMBODIMENTS

The present invention is further described below in conjunction with the accompanying drawings, and the protection scope of the present invention is not limited to the following description:

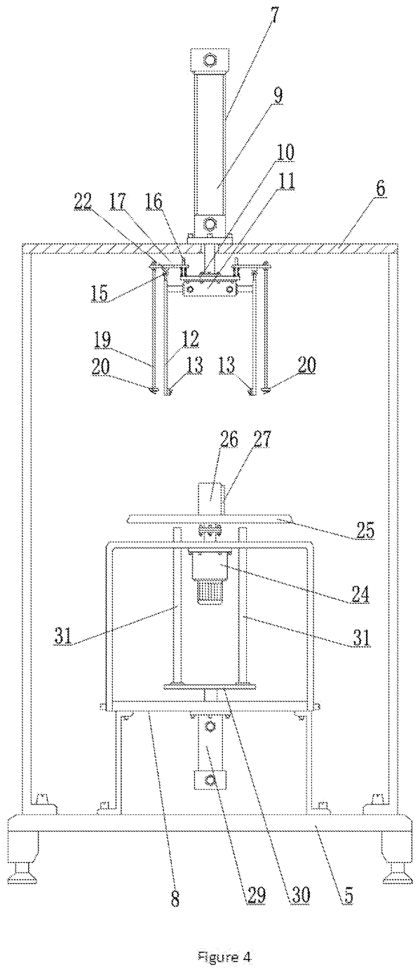

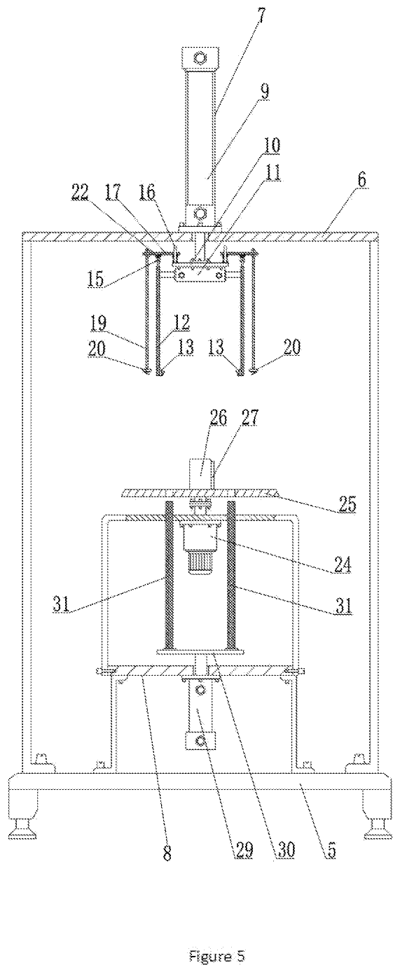

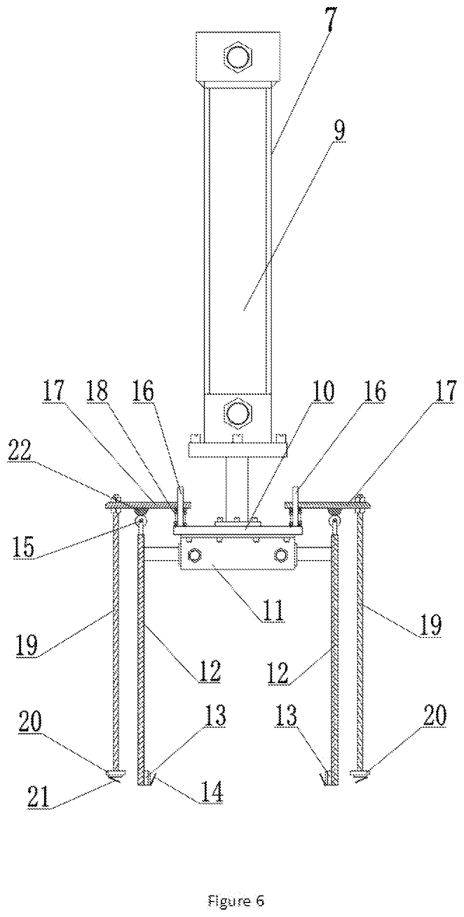

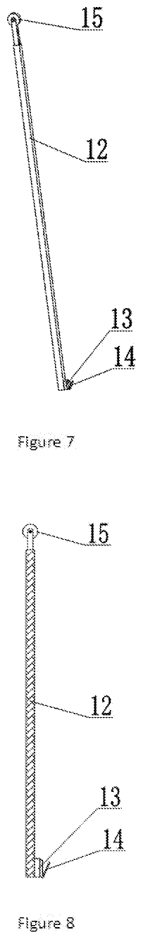

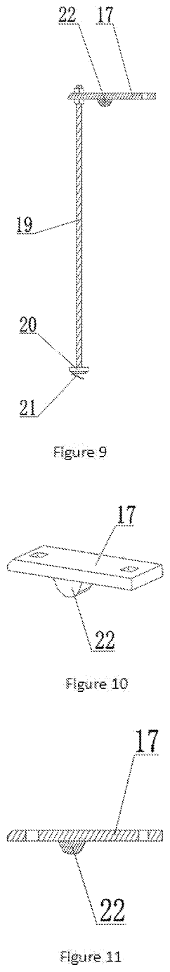

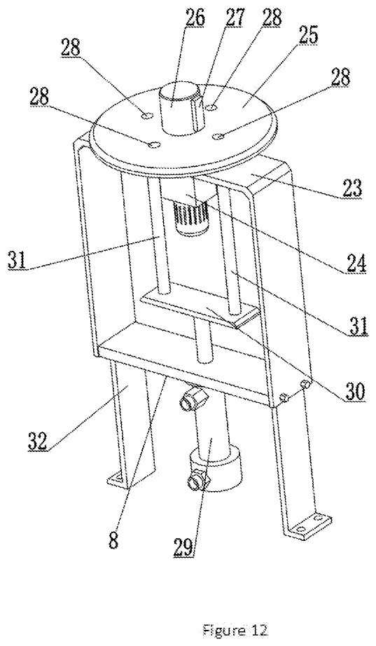

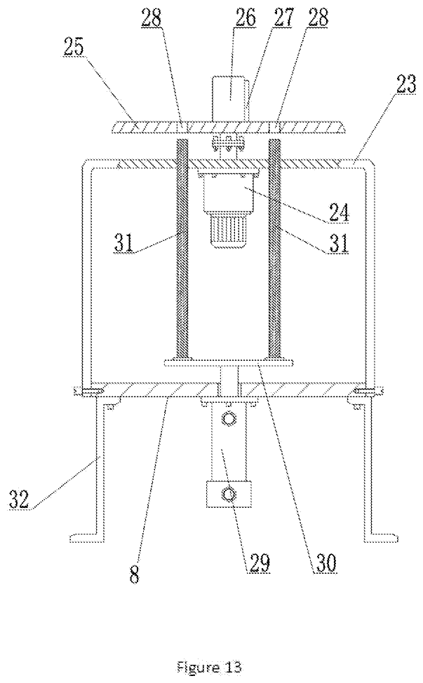

As shown in FIGS. 4 to 13, a device for inspecting openings of a powder metallurgy disk body with multiple openings comprises a workbench 5, wherein an arch frame 6 is fixedly provided on the workbench 5, an inspection unit 7 for inspecting depth and width of openings 4 in a powder metallurgy disk body 1 is arranged on the arch frame 6, a positioning and ejection mechanism 8 for positioning and ejecting the powder metallurgy disk body 1 is also arranged on the workbench 5, and the positioning and ejection mechanism 8 is arranged directly below the inspection unit 7; a plurality of pads supported on grounds are fixedly provided on a bottom surface of the workbench 5.

The inspection unit 7 comprises a lifting cylinder 9 fixedly mounted on a top surface of the arch frame 6, wherein a piston rod of the lifting cylinder 9 penetrates downwardly through the arch frame 6, a connecting plate 10 is fixedly mounted on an extended end, a horizontally arranged double-acting cylinder 11 is fixedly mounted on a bottom surface of the connecting plate 10, rods 12 are welded to two piston rods of the double-acting cylinder 11, lateral micro switches 13 are fixedly mounted on inner side walls of lower ends of the two rods 12, spring pieces A 14 of the lateral micro switches 13 are arranged inwardly, and rollers 15 are rotatably mounted on upper ends of the two rods 12 via pins.

Guide rods 16 are fixedly provided on a top surface of the connecting plate 10 and located at left and right ends of the connecting plate, and lifting plates 17 are slidably sleeved on the two guide rods 16, springs 18 are sleeved on the two guide rods 16, and upper and lower ends of the springs 18 are respectively fixedly provided on the lifting plates 17 and the connecting plate 10; the two lifting plates 17 are both extended outside the rods 12, and a floating rod 19 is fixedly provided on an extended end, vertical micro switches 20 are fixedly provided on bottom surfaces of the two floating rods 19, and spring pieces B 21 of the vertical micro switches 20 are arranged downward; the bottom surfaces of the two lifting plates 17 are both fixedly provided with arc-shaped protrusions 22, and the two arc-shaped protrusions 22 respectively abut against top surfaces of the two rollers 15 under elastic force of the springs 18.

The positioning and ejection mechanism 8 comprises a frame 23 fixedly mounted on a surface of the workbench 5, a stepper motor 24 fixedly mounted on a top surface of the frame 23, and a turntable 25 fixedly mounted on an output shaft of the stepper motor 24; a positioning column 26 is fixedly mounted on a top surface of the turntable 25, a flat key 27 is fixedly mounted on a cylindrical surface of the positioning column 26 along an axial direction of the positioning column 26, and four through holes 28 are evenly opened in the turntable 25 along a circumferential direction of the positioning column 26; an outer diameter of the positioning column 26 is compatible with a central hole 2 of the powder metallurgy disk body 1, and the flat key 27 is compatible with a keyway 3 of the powder metallurgy disk body 1. The lifting cylinder 9, the positioning column 26, the turntable 25 and the stepper motor 24 are coaxially arranged.

A jacking cylinder 29 is fixedly provided on a bottom surface of the frame 23, at least one piston rod of the jacking cylinder 29 extends into the frame 23, and a jacking plate 30 is fixedly provided on an extended end, two jacking rods 31 are fixedly provided on a top surface of the jacking plate 30, both of the two jacking rods 31 penetrate upward through a top edge of the frame 23, and the two jacking rods 31 are respectively located directly below the two through holes 28 in the turntable 25. A connecting frame 32 is fixedly provided between the bottom surface of the frame 23 and the workbench 5.

The inspection device further comprises a controller, and the controller is electrically connected to the lifting cylinder 9, the double-acting cylinder 11, the jacking cylinder 29, the stepper motor 24, the lateral micro switches 13, and the vertical micro switches 20 via a signal line. The worker can control the extension or retraction of the piston rods of the lifting cylinder 9 and the jacking cylinder 29 through the controller, and can also control the two piston rods of the double-acting cylinder 11 to extend or retract at the same time, and, meanwhile, control the stepping motor 24 to start up or shut down, which facilitates the operation of the worker and has the feature of high degree of automation.

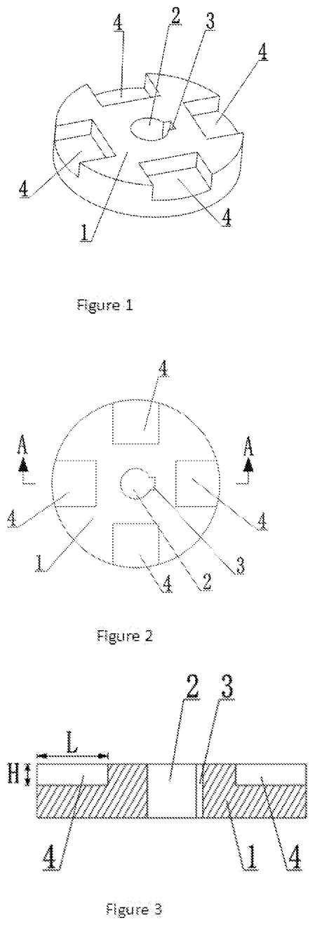

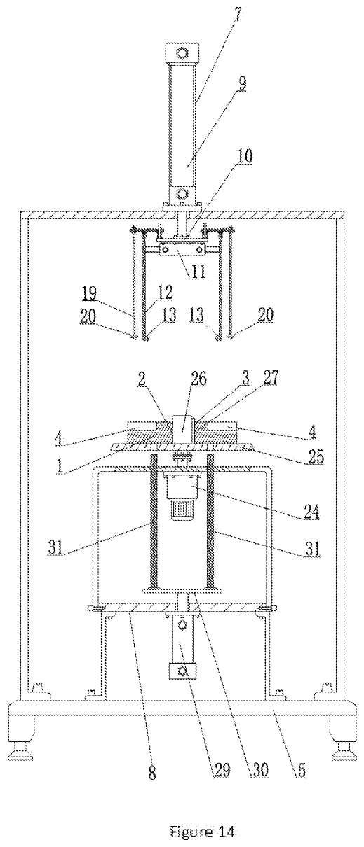

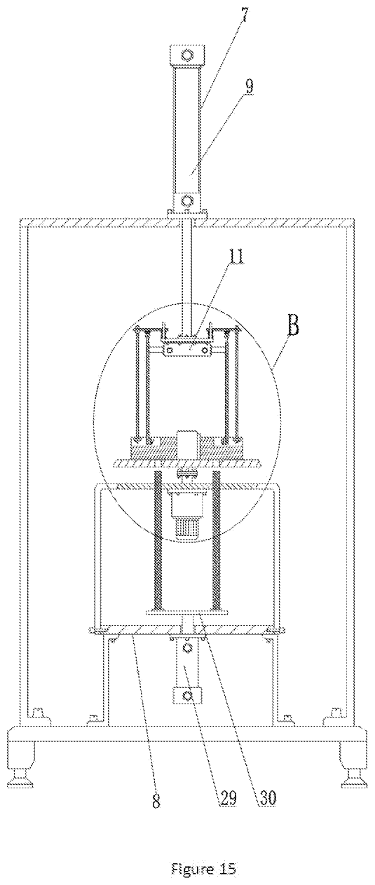

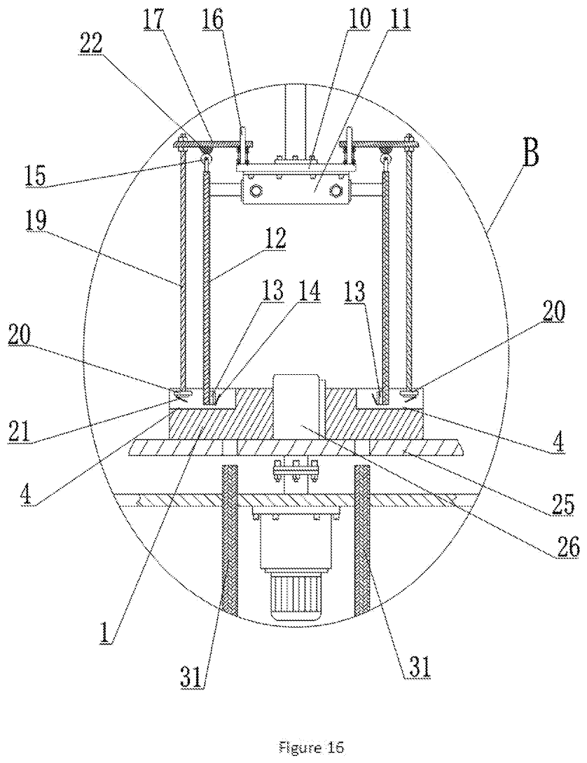

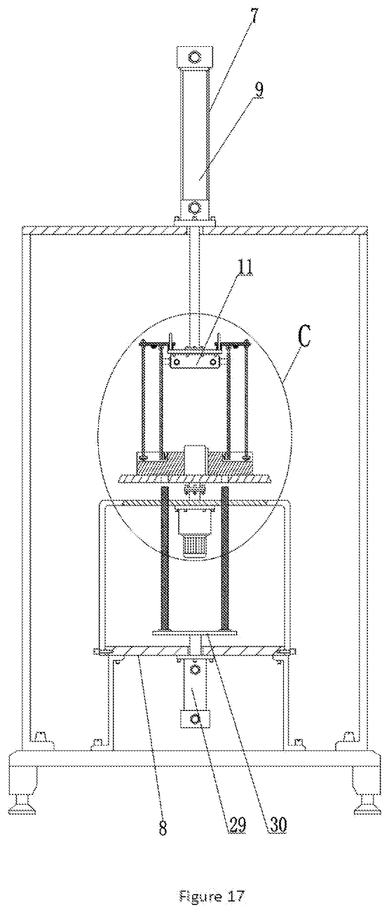

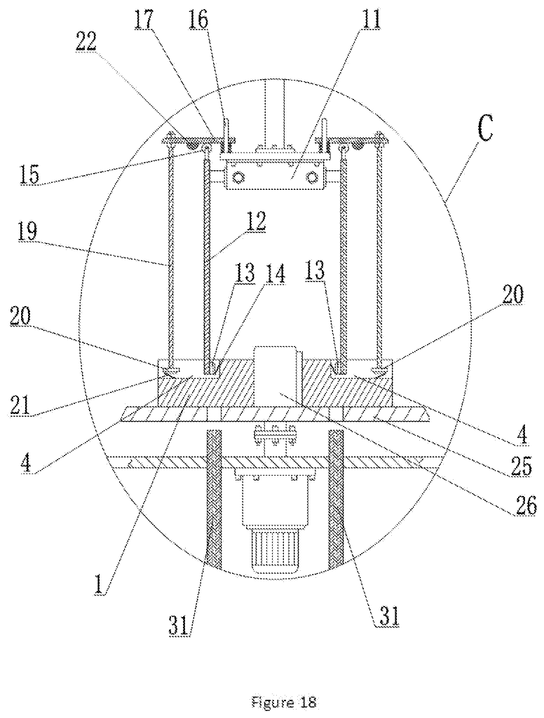

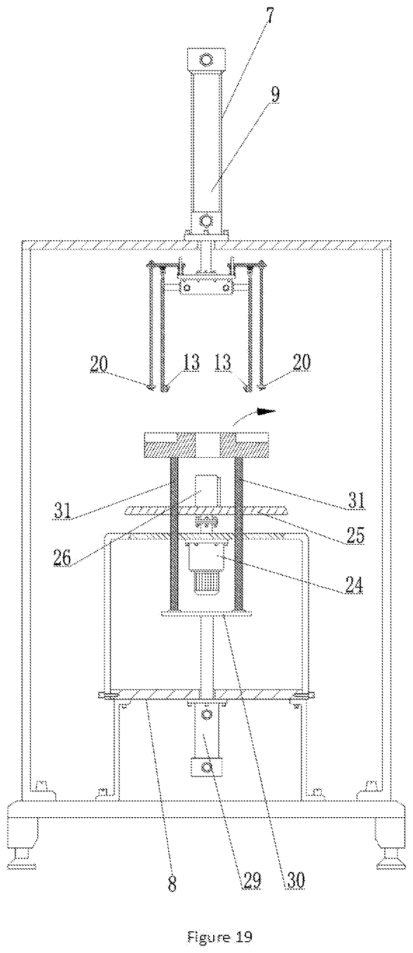

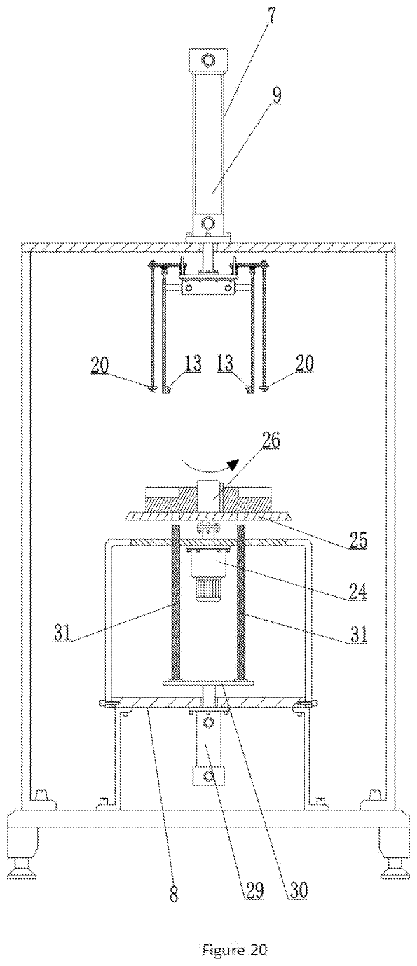

A method for detecting openings of a powder metallurgy disk body with multiple openings comprises following steps:
S1, positioning of a powder metallurgy disk body 1 to be inspected: S1, taking out a powder metallurgy disk body 1 to be inspected by workers as shown in FIGS. 1 to 3, sleeving the central hole 2 of the powder metallurgy disk body 1 on the positioning column 26 of the positioning and ejection mechanism 8 from top to bottom, and sleeving the keyway 3 of the powder metallurgy disk body 1 on the flat key 27 of the positioning and ejection mechanism 8 from top to bottom; subsequently supporting the powder metallurgy disk body 1 on a top surface of the turntable 25, thereby achieving the positioning of the powder metallurgy disk body 1 as shown in FIG. 14; at this time, a left opening 4 of the powder metallurgy disk body 1 is located directly below the lateral micro switches 13 and the vertical micro switches 20 on a left side, and a right opening 4 of the powder metallurgy disk body 1 is located directly below the lateral micro switches 13 and the vertical micro switches 20 on a right side;
S2, detecting two openings 4 within the powder metallurgy disk body 1 in following steps:
S21, controlling the piston rod of the lifting cylinder 9 of the inspection unit 7 to extend downward, so that the piston rod drives the connecting plate 10 to move downward, the connecting plate 10 drives the double-acting cylinder 11, two guide rods 16, two floating rods 19, two lateral micro switches 13 and two vertical micro switches 20 to move downward synchronously; when the piston rod of the lifting cylinder 9 is fully extended, the lateral micro switches 13 and the vertical micro switches 20 located on the left side both enter the left opening 4 of the powder metallurgy disk body 1 as shown in FIGS. 15 to 16, and meanwhile, the lateral micro switches 13 and the vertical micro switches 20 located on the right side both enter the right opening 4 of the powder metallurgy disk body 1;
S22, controlling the two piston rods of the double-acting cylinder 11 of the inspection unit 7 to retract inward simultaneously, so that the two piston rods respectively drive the two rods 12 to move inward, the rods 12 drive the lateral micro switches 13 and the rollers 15 to move inward synchronously, and the spring pieces A 14 of the lateral micro switches 13 move toward side walls of the openings 4; meanwhile, the rollers 15 are gradually staggered with the arc-shaped protrusions 22 on the lifting plates 17, and in a process of gradually staggering, the lifting plates 17 move downward along the guide rods 16, the lifting plates 17 drive the floating rods 19 to move downward, the floating rods 19 drive the vertical micro switches 20 to move downward, and the spring pieces B 21 of the vertical micro switches 20 move toward bottom walls of the openings 4;
when both piston rods of the double-acting cylinder 11 are fully retracted as shown in the FIGS. 17 to 18, the rods 12 no longer drive the lateral micro switches 13 to move inward, and meanwhile, the rollers 15 are just staggered from the arc-shaped protrusions 22 on the lifting plates 17;
if a controller receives an electrical signal from the lateral micro switches 13 or the vertical micro switches 20 (the spring pieces A14 of the lateral micro switches 13 press the side wall of the openings 4, and the lateral micro switches 13 send an electrical signal to the controller; the spring pieces B21 of the vertical micro switches 20 press the bottom wall of the openings 4, and the vertical micro switches 20 send an electrical signal to the controller), it indicates that width or depth of inspected openings 4 does not meet design requirements, and the workers determine that the powder metallurgy disk body 1 is a defective product; at this time, the workers take out the defective product in following steps: first, controlling the piston rod of the lifting cylinder 9 to be retracted upward by the workers so that the lateral micro switches 13 and the vertical micro switches 20 are reset upward; then, controlling the piston rod of the jacking cylinder 29 to extend upward; the piston rod drives the jacking plate 30 to move upward, and the jacking plate 30 drives two jacking rods 31 to move upward; the jacking rods 31 pass through the through holes 28 and lift the defective product upward along the positioning column 26; when the defective product is lifted to an outside portion of the positioning column 26, as shown in FIG. 19, the workers take the defective product away in an direction of an arrow in FIG. 19;
if the controller does not receive the electrical signal from the lateral micro switches 13 and the vertical micro switches 20 (the spring pieces A14 of the lateral micro switches 13 do not press the side wall of the openings 4, and the lateral micro switches 13 will not send an electrical signal to the controller; the spring pieces B21 of the vertical micro switches 20 do not press the bottom wall of the openings 4, and the vertical micro switches 20 will not send an electrical signal to the controller), it indicates that the width or depth of the inspected openings 4 meets the design requirements, and the workers determine that the powder metallurgy disk body 1 is a semi-qualified product, thereby finally completing detection of the two openings 4 within the powder metallurgy disk body 1;
S3, detecting two openings 4 in the semi-qualified product in following steps:
S31, controlling the two piston rods of the double-acting cylinder 11 to extend outward by the workers, so that the two piston rods respectively drive the two rods 12 to move outward, and the arc-shaped protrusions 22 on the lifting plates 17 abut against a top portion of the rollers 15 again;
S32, controlling the piston rod of the lifting cylinder 9 to retract upward, so that the piston rod drives the connecting plate 10 to move upward, and the connecting plate 10 drives the double-acting cylinder 11, the two guide rods 16, the two floating rods 19, the two lateral micro switches 13 and the two vertical micro switches 20 to move upward synchronously to reset the lateral micro switches 13 and the vertical micro switches 20;
S33, controlling the stepper motor 24 to start, so that the stepper motor 24 drives the turntable 25 to rotate, the turntable 25 drives the positioning column 26 and the flat key 27 to rotate, and the positioning column 26 and the flat key 27 drive the semi-qualified product to rotate synchronously; when the semi-qualified product is rotated 90 degrees, the controller controls the stepper motor 24 to turn off; at this time, the other two openings 4 in the semi-qualified product enter a detection station, and the lateral micro switches 13 and the vertical micro switches 20 located on the left side enter the left opening 4 of the semi-qualified product; meanwhile, the lateral micro switches 13 and the vertical micro switches 20 located on the right side enter the right opening 4 of the semi-qualified product;
S34, repeating operation of steps S21 to S22 once by the workers;
if the controller receives the electrical signal from the lateral micro switches 13 or the vertical micro switches 20, it indicates that the width or depth of the inspected openings 4 does not meet the design requirements, and the workers determine that the semi-qualified product 1 is a defective product; at this time, the workers take out the defective product in following steps: first, controlling the piston rod of the lifting cylinder 9 to be retracted upward by the workers so that the lateral micro switches 13 and the vertical micro switches 20 are reset upward; then, controlling the piston rod of the jacking cylinder 29 to extend upward; when the defective product is lifted to an outside portion of the positioning column 26, the workers take the defective product away;
if the controller does not receive the electrical signal from the lateral micro switches 13 and the vertical micro switches 20, it indicates that the width or depth of the inspected openings 4 meets the design requirements, and the workers determine that the semi-qualified product 1 is a qualified product, so that the workers control the piston rod of the lifting cylinder 29 to extend upward; when the qualified product is lifted up, the workers take the qualified product away, thereby completing the inspection of the two openings 4 in the semi-qualified product, and finally completing the inspection of the four openings 4 in the powder metallurgy disk body 1;
S4, repeating steps S1 to S3 multiple times by the workers to allow the openings 4 of all powder metallurgy disk bodies 1 in a workshop to be inspected;
wherein, as can be seen from step S2, the worker only needs to control linkage cooperation of the lifting cylinder 9 and the double-acting cylinder 11 of the inspection unit 7 to move the spring pieces A14 of the lateral micro switches 13 toward the side walls of the openings 4 of the powder metallurgy disk body 1, and move the spring pieces B21 of the vertical micro switches 20 toward the bottom walls of the openings 4 of the powder metallurgy disk body 1, thereby inspecting the two openings 4 in the powder metallurgy disk body 1, and judging that the powder metallurgy disk body 1 is an unqualified product or a semi-qualified product. As can be seen from step S3, the worker only needs to control linkage cooperation of the lifting cylinder 9 and the double-acting cylinder 11 of the inspection unit 7 to make the spring pieces A14 of the lateral micro switches 13 move toward the side walls of the openings 4 of the half-qualified product, and make the spring pieces B21 of the vertical micro switches 20 move toward the bottom walls of the openings 4 of the half-qualified product, thereby inspecting the two openings 4 in the semi-qualified product, and then judging whether the semi-qualified product is an unqualified product or a qualified product, and then quickly completing the inspection of the four openings of the powder metallurgy disk body 1.

As can be seen, the present inspection device is capable of inspecting two openings 4 at one time by means of the linkage cooperation of the inspection unit 7, the positioning and ejection mechanism 8, i.e. all four openings 4 in the powder metallurgy disk body 1 can be inspected by repeating the steps S2˜S3 only twice. Compared to the manual inspection method in the workshop, there is no need for workers to inspect the openings 4 in multiple processes, which not only greatly reduces the work intensity of the workers, but also achieves the completion of the inspection of the four openings 4 in one powder metallurgy disk body 1 in a short period of time, and thus greatly improves the efficiency of inspecting the openings of the powder metallurgy disk body.

In addition, the present inspection device also achieves the completion of the inspection of the openings 4 of a plurality of powder metallurgy disk bodies 1 in a workshop in a short time, which further improves the efficiency of the inspection of the openings of the powder metallurgy disk bodies.

What is claimed is:

1. A device for inspecting openings of a powder metallurgy disk body with multiple openings comprising a workbench (5), wherein an arch frame (6) is fixedly provided on the workbench (5), an inspection unit (7) for inspecting depth and width of openings (4) in a powder metallurgy disk body (1) is arranged on the arch frame (6), a positioning and ejection mechanism (8) for positioning and ejecting the powder metallurgy disk body (1) is also arranged on the workbench (5), and the positioning and ejection mechanism (8) is arranged directly below the inspection unit (7);
the inspection unit (7) comprises a lifting cylinder (9) fixedly mounted on a top surface of the arch frame (6), wherein a piston rod of the lifting cylinder (9) penetrates downwardly through the arch frame (6), a connecting plate (10) is fixedly mounted on an extended end, a horizontally arranged double-acting cylinder (11) is fixedly mounted on a bottom surface of the connecting plate (10), rods (12) are welded to two piston rods of the double-acting cylinder (11), lateral micro switches (13) are fixedly mounted on inner side walls of lower ends of the two rods (12), spring pieces A (14) of the lateral micro switches (13) are arranged inwardly, and rollers (15) are rotatably mounted on upper ends of the two rods (12) via pins;
guide rods (16) are fixedly provided on a top surface of the connecting plate (10) and located at left and right ends of the connecting plate, and lifting plates (17) are slidably sleeved on the two guide rods (16), springs (18) are sleeved on the two guide rods (16), and upper and lower ends of the springs (18) are respectively fixedly provided on the lifting plates (17) and the connecting plate (10); the two lifting plates (17) are both extended outside the rods (12), and a floating rod (19) is fixedly provided on an extended end, vertical micro switches (20) are fixedly provided on bottom surfaces of the two floating rods (19), and spring pieces B (21) of the vertical micro switches (20) are arranged downward; the bottom surfaces of the two lifting plates (17) are both fixedly provided with arc-shaped protrusions (22), and the two arc-shaped protrusions (22) respectively abut against top surfaces of the two rollers (15) under elastic force of the springs (18).

2. The device for inspecting openings of a powder metallurgy disk body with multiple openings according to claim 1, wherein a plurality of pads supported on grounds are fixedly provided on a bottom surface of the workbench (5).

3. The device for inspecting openings of a powder metallurgy disk body with multiple openings according to claim 2, wherein the positioning and ejection mechanism (8) comprises a frame (23) fixedly mounted on a surface of the workbench (5), a stepper motor (24) fixedly mounted on a top surface of the frame (23), and a turntable (25) fixedly mounted on an output shaft of the stepper motor (24); a positioning column (26) is fixedly mounted on a top surface of the turntable (25), a flat key (27) is fixedly mounted on a cylindrical surface of the positioning column (26) along an axial direction of the positioning column (26), and four through holes (28) are evenly opened in the turntable (25) along a circumferential direction of the positioning column (26);
a jacking cylinder (29) is fixedly provided on a bottom surface of the frame (23), at least one piston rod of the jacking cylinder (29) extends into the frame (23), and a jacking plate (30) is fixedly provided on an extended end, two jacking rods (31) are fixedly provided on a top surface of the jacking plate (30), both of the two jacking rods (31) penetrate upward through a top edge of the frame (23), and the two jacking rods (31) are respectively located directly below the two through holes (28) in the turntable (25).

4. The device for inspecting openings of a powder metallurgy disk body with multiple openings according to claim 3, wherein an outer diameter of the positioning column (26) is compatible with a central hole (2) of the powder metallurgy disk body (1), and the flat key (27) is compatible with a keyway (3) of the powder metallurgy disk body (1).

5. The device for inspecting openings of a powder metallurgy disk body with multiple openings according to claim 4, wherein a connecting frame (32) is fixedly provided between the bottom surface of the frame (23) and the workbench (5).

6. The device for inspecting openings of a powder metallurgy disk body with multiple openings according to claim 5, wherein the lifting cylinder (9), the positioning column (26), the turntable (25) and the stepper motor (24) are coaxially arranged.

7. The device for inspecting openings of a powder metallurgy disk body with multiple openings according to claim 6, wherein the two lateral micro switches (13) are symmetrically arranged with respect to the double-acting cylinder (11), and the two vertical micro switches (20) are symmetrically arranged with respect to the double-acting cylinder (11).

8. The device for inspecting openings of a powder metallurgy disk body with multiple openings according to claim 7, wherein the inspection device further comprises a controller, and the controller is electrically connected to the lifting cylinder (9), the double-acting cylinder (11), the jacking cylinder (29), the stepper motor (24), the lateral micro switches (13) and the vertical micro switches (20) via a signal line.

9. A method for detecting openings of a powder metallurgy disk body with multiple openings, using the device for detecting openings of a powder metallurgy disk body with multiple openings according to claim 8, comprising following steps: S1, positioning of a powder metallurgy disk body (1) to be inspected: S1, taking out a powder metallurgy disk body (1) to be inspected by workers, sleeving the central hole (2) of the powder metallurgy disk body (1) on the positioning column (26) of the positioning and ejection mechanism (8) from top to bottom, and sleeving the keyway (3) of the powder metallurgy disk body (1) on the flat key (27) of the positioning and ejection mechanism (8) from top to bottom; subsequently supporting the powder metallurgy disk body (1) on a top surface of the turntable (25), thereby achieving the positioning of the powder metallurgy disk body (1); at this time, a left opening (4) of the powder metallurgy disk body (1) is located directly below the lateral micro switches (13) and the vertical micro switches (20) on a left side, and a right opening (4) of the powder metallurgy disk body (1) is located directly below the lateral micro switches (13) and the vertical micro switches (20) on a right side;
S2, detecting two openings (4) within the powder metallurgy disk body (1) in following steps:
S21, controlling the piston rod of the lifting cylinder (9) of the inspection unit (7) to extend downward, so that the piston rod drives the connecting plate (10) to move downward, the connecting plate (10) drives the double-acting cylinder (11), two guide rods (16), two floating rods (19), two lateral micro switches (13) and two vertical micro switches (20) to move downward synchronously; when the piston rod of the lifting cylinder (9) is fully extended, the lateral micro switches (13) and the vertical micro switches (20) located on the left side both enter the left opening (4) of the powder metallurgy disk body (1), and meanwhile, the lateral micro switches (13) and the vertical micro switches (20) located on the right side both enter the right opening (4) of the powder metallurgy disk body (1);
S22, controlling the two piston rods of the double-acting cylinder (11) of the inspection unit (7) to retract inward simultaneously, so that the two piston rods respectively drive the two rods (12) to move inward, the rods (12) drive the lateral micro switches (13) and the rollers (15) to move inward synchronously, and the spring pieces A (14) of the lateral micro switches (13) move toward side walls of the openings (4); meanwhile, the rollers (15) are gradually staggered with the arc-shaped protrusions (22) on the lifting plates (17), and in a process of gradually staggering, the lifting plates (17) move downward along the guide rods (16), the lifting plates (17) drive the floating rods (19) to move downward, the floating rods (19) drive the vertical micro switches (20) to move downward, and the spring pieces B (21) of the vertical micro switches (20) move toward bottom walls of the openings (4);
when both piston rods of the double-acting cylinder (11) are fully retracted, the rods (12) no longer drive the lateral micro switches (13) to move inward, and meanwhile, the rollers (15) are just staggered from the arc-shaped protrusions (22) on the lifting plates (17);
if a controller receives an electrical signal from the lateral micro switches (13) or the vertical micro switches (20), it indicates that width or depth of inspected openings (4) does not meet design requirements, and the workers determine that the powder metallurgy disk body (1) is an unqualified product; at this time, the workers take out the unqualified product in following steps: first, controlling the piston rod of the lifting cylinder (9) to be retracted upward by the workers so that the lateral micro switches (13) and the vertical micro switches (20) are reset upward; then, controlling the piston rod of the jacking cylinder (29) to extend upward; the piston rod drives the jacking plate (30) to move upward, and the jacking plate (30) drives two jacking rods (31) to move upward; the jacking rods (31) pass through the through holes (28) and lift the unqualified product upward along the positioning column (26); when the unqualified product is lifted to an outside portion of the positioning column (26), the workers take the unqualified product away;
if the controller does not receive the electrical signal from the lateral micro switches (13) and the vertical micro switches (20), it indicates that the width or depth of the inspected openings (4) meets the design requirements, and the workers determine that the powder metallurgy disk body (1) is a semi-qualified product, thereby finally completing detection of the two openings (4) within the powder metallurgy disk body (1);
S3, detecting two openings (4) in the semi-qualified product in following steps:
S31, controlling the two piston rods of the double-acting cylinder (11) to extend outward by the workers, so that the two piston rods respectively drive the two rods (12) to move outward, and the arc-shaped protrusions (22) on the lifting plates (17) abut against a top portion of the rollers (15) again;
S32, controlling the piston rod of the lifting cylinder (9) to retract upward, so that the piston rod drives the connecting plate (10) to move upward, and the connecting plate (10) drives the double-acting cylinder (11), the two guide rods (16) the two floating rods (19), the two lateral micro switches (13) and the two vertical micro switches (20) to move upward synchronously to reset the lateral micro switches (13) and the vertical micro switches (20);
S33, controlling the stepper motor (24) to start, so that the stepper motor (24) drives the turntable (25) to rotate, the turntable (25) drives the positioning column (26) and the flat key (27) to rotate, and the positioning column (26) and the flat key (27) drive the semi-qualified product to rotate synchronously; when the semi-qualified product is rotated 90 degrees, the controller controls the stepper motor (24) to turn off; at this time, the other two openings (4) in the semi-qualified product enter a detection station, and the lateral micro switches (13) and the vertical micro switches (20) located on the left side enter the left opening (4) of the semi-qualified product; meanwhile, the lateral micro switches (13) and the vertical micro switches (20) located on the right side enter the right opening (4) of the semi-qualified product;
S34, repeating operation of steps S21 to S22 once by the workers;
if the controller receives the electrical signal from the lateral micro switches (13) or the vertical micro switches (20), it indicates that the width or depth of the inspected openings (4) does not meet the design requirements, and the workers determine that the semi-qualified product (1) is an unqualified product; at this time, the workers take out the unqualified product in following steps: first, controlling the piston rod of the lifting cylinder (9) to be retracted upward by the workers so that the lateral micro switches (13) and the vertical micro switches (20) are reset upward; then, controlling the piston rod of the jacking cylinder (29) to extend upward; when the unqualified product is lifted to an outside portion of the positioning column (26), the workers take the unqualified product away;
if the controller does not receive the electrical signal from the lateral micro switches (13) and the vertical micro switches (20), it indicates that the width or depth of the inspected openings (4) meets the design requirements, and the workers determine that the semi-qualified product (1) is a qualified product, so that the workers control the piston rod of the lifting cylinder (29) to extend upward; when the qualified product is lifted up, the workers take the qualified product away, thereby completing the inspection of the two openings (4) in the semi-qualified product, and finally completing the inspection of the four openings (4) in the powder metallurgy disk body (1);
S4, repeating steps S1 to S3 multiple times by the workers to allow the openings (4) of all powder metallurgy disk bodies (1) in a workshop to be inspected
